(19) United States
(12) Patent Application Publication
(10) Pub. No.: US 2006/0092938 A1
(43) Pub. Date: May 4, 2006

(54) System for broadcasting multimedia content

(75) Inventor: Philippe Gentrix, Fourqueux (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/546,393

(22) PCT Filed: Feb. 6, 2004
(86) PCT No.: PCT/IB04/00450

§ 371 Date: Aug. 18, 2005

(30) Foreign Application Priority Data
Feb. 26, 2003 (EP) 032904534

(51) Int. Cl. H04L 12/56

(52) U.S. Cl. 370/390

(57) ABSTRACT

The invention relates to a telecommunication system for broadcasting multimedia content (MM) to a client device (60). Said system comprises an encoder (20) for encoding said multimedia content in an encoded data stream (EDS). Said encoded data stream is transmitted via a first network connection (30) to a server (40). Said server (40) is able to generate metadata (MT) from media data (MD) contained in the received encoded data stream (EDS) and to create a progressive file (PF), in which said media data (MD) and metadata (MT) are interleaved. Said progressive file (PF) is downloaded via a second network connection (50) to a client device (60), which is able to start playing the received multimedia content before the end of the download, using said interleaved meta and media data.

### FIELD OF THE INVENTION

The invention relates to a telecommunication system for broadcasting multimedia content to a client device. The invention also relates to a server to be used in such a system. The invention further relates to a client device for requesting said multimedia content from such a server. The invention finally relates to a method for use in said system.

The invention finds for example its application for broadcasting live multimedia content to a client via the Internet or mobile networks.

### BACKGROUND OF THE INVENTION

Streaming of live audio, video and all kinds of multimedia content on the Internet is becoming widespread. As shown in FIG. 1, a streaming session involves a real-time encoder for encoding live multimedia content in real time and supplying an encoded data stream, a broadcast connection between said encoder and a streaming server and several point to point connections between said server and several clients. The standard protocol used for such real time transmissions on IP networks is the Real Time Protocol (RTP). Said encoded data stream is therefore converted into RTP packets, which are transmitted to the server and further to the clients.

A problem raised by said RTP protocol is that the RTP packets are often blocked by firewalls and Network Address Translators (NATs). As a consequence, the clients are unable to receive the requested multimedia content.

A solution to circumvent this issue is already known from the publication “An RTP to HTTP video gateway” by Mathias Johanson, ACM, 1-58113-348-0/01/0005, 2001. Said solution consists in converting the RTP packets into a file, which is included in a web page of a server and transmitted to a client using the Hyper Text Transport Protocol (HTTP) instead of the RTP protocol. An advantage of said HTTP protocol is that it is accepted by all firewalls and works well with NATs.

In this prior art, a video content comprising a sequence of images is encoded into a MJPEG (Motion Joint Picture Expert Group) stream. MJPEG is a standard format for encoding video, which consists in encoding each image of the sequence separately using the JPEG format developed for still pictures. Said MJPEG stream is further converted into a RTP stream as described in the Request For Comment RFC 2435. Said RTP stream is transmitted to a web server via a RTP multicast connection. Said web server comprises converting means for converting said RTP stream into a Multipurpose Internet Mail Extension multipart (MIME multipart) file. MIME multipart is a standard for specifying and describing the format of Internet message bodies, which makes it possible to display sequences of JPEG images in a HTML web page. In Johanson's solution, a JPEG image of the MJPEG stream is stored in one part of the MIME multipart file. Said MIME file is made accessible by its URL (Uniform Resource Locators, see Request for Comment number 1738) address on a web page available on said web server. When a client browses said web page and clicks on said URL address, a specific Java applet is downloaded and launched at the client side for ordering and synchronizing the downloads of the successive JPEG images of the MJPEG file. Once received by the client, a JPEG image is decoded by a JPEG decoder, while the next JPEG image is being downloaded. Therefore, the MJPEG video sequence is played in real time.

A major drawback of this solution is that it is very specific. The MIME multipart format only accepts still picture encoding formats like JPEG or GIF. The MJPEG format, which encodes a video sequence as a collection of independent JPEG images and consequently does not exploit the temporal redundancy of the video sequence, does not achieve a sufficient compression ratio for allowing video streaming via low bit rate network connections, like Internet or mobile networks. The MJPEG format is very interesting for studio composition, but it is not widespread at all for video streaming on the Internet. In order to use another video encoding format like MPEG-4, a conversion is needed, which would lead to an important quality drop.

Another drawback of this method is that it does not work for other kinds of multimedia content than video, like audio or text. It does not give solutions for synchronizing several multimedia sources either. For instance, such a method does not provide any solution for streaming a movie via the Internet.

### SUMMARY OF THE INVENTION

It is an object of the invention to propose a more efficient solution for broadcasting video and more generally all kind of multimedia content on the Internet via a server.

This is achieved with a telecommunication system as defined in claims 1 to 4, a server as defined in claims 5 to 7, a client device as defined in claim 8, a method as defined in claims 9 and 10, a computer program as defined in claim 11 and a signal as defined in claim 12.

According to the invention, multimedia content is encoded in an encoded data stream. Said encoded data stream is distributed in real time via a broadcast transmission to a server. On IP networks, the broadcast transmission between the encoder and the server is usually a multicast connection ruled by the RTP (Real Time Protocol) protocol. The server is then able to convert the received encoded data stream into a “progressive” file, said progressive file having a format compatible with progressive download, and to make said progressive file available to the client device, for instance on a web page.

Said progressive file is transmitted from server to client via a point-to-point network connection. On IP networks, said point-to-point network connection is usually ruled by the HTTP protocol (Hyper Text Transfer Protocol, see RFC 2616). Said HTTP protocol, which is the basis for the World Wide Web, has the great advantage of being accepted by all firewalls and NATs.

Progressive download of a file consists in starting to decode the file before its complete download. This is made possible by a file format having a structure where media data and metadata are interleaved. Media data comprise audio, video, pictures or text tracks of the encoded multimedia content. Metadata describe the way the media data are encoded. Using said file format, decoding can therefore be achieved on a fragment of the file provided that said fragment contains media data and the metadata related to said media data.

According to the invention, said client is expected to connect to the server at any time during the broadcast of said multimedia content, and to ask for receiving said multimedia content on the fly. To this end, said server is able to customize said progressive file into a client progressive file adapted to the client request. Said client progressive file comprises metadata for allowing the client to catch up a current multimedia broadcast, like initialization metadata, which are normally sent before starting the broadcast, for instance to configure the player.

In a preferred embodiment of the invention, the file format used is the ISO file format version 2, which is readable by a number of multimedia data encoding standards like MPEG-4 or H.263 for video or AMR (Advanced Multi Rate) for audio.

A first advantage of the invention is that these standards are widespread for multimedia data compression. For instance, MPEG-4 or an equivalent standard is widely used by content providers on the Internet. Consequently no transcoding means are needed at the server side, as it would often be the case in Johanson's solution in order to transcode a MPEG-4 stream into a M-JPEG stream.

A second advantage is that said standards for video encoding achieve a far better compression ratio than MJPEG at any bit rate, from very low to high bit rates. This gain of quality is particularly relevant when the client is a mobile phone or a personal computer with a modem Internet connection and is limited by a low bit rate network connection.

Said ISO file format version 2 is also able to interleave multimedia data from different sources like audio, video, pictures or text and therefore to provide the player of the client with encoded data where synchronized audio, video and text are available at the same time. Combined with a multimedia standard, like MPEG-4, which has been especially designed for handling multimedia sources, said ISO file format version 2 allows transmission of multimedia data to a client via a download server. Another advantage of the invention is thus that a solution is proposed for broadcasting any kind of multimedia content, i. e. synchronized audio, video, text and pictures, and not only video, which is more adapted to present-day applications on the Internet.

The system according to the invention is also advantageous, because it enables the client to keep a copy of the received client progressive file. The server may also limit the number of authorized copies using DRM (Data Resource Management). This could not be done easily in using Johanson's solution, because of the Java applet, which does not a priori have the right to write data into the file system of the client.

These and other aspects of the invention are apparent from and will be elucidated with reference to the embodiments described hereinafter.

### BRIEF DESCRIPTION OF THE DRAWINGS

The invention will be further described with reference to the accompanying drawings:

FIG. 1 is a diagram illustrating a telecommunication system for streaming multimedia data via a real-time network connection,

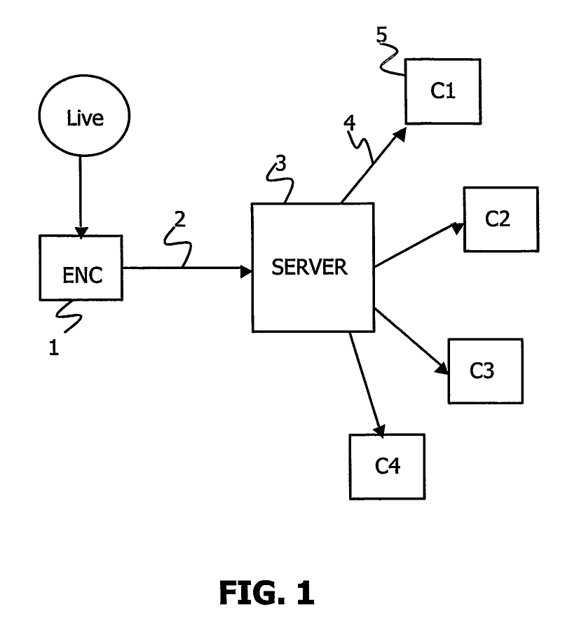

FIG. 2 is a block diagram illustrating a telecommunication system for broadcasting multimedia content via a first network connection, a server and a second network connection according to the invention,

FIG. 3 depicts the structure of a file in accordance with the ISO file format version 2,

FIG. 4 shows in a functional way how the customizing means are able to build a client progressive file adapted to a client request, according to the invention,

FIG. 5 depicts the structure of a client progressive file according to the invention,

FIG. 6 is a schematic representation of an embodiment of the invention, wherein said server comprises repairing means for repairing the media data contained in the received encoded data stream.

### DETAILED DESCRIPTION OF THE INVENTION

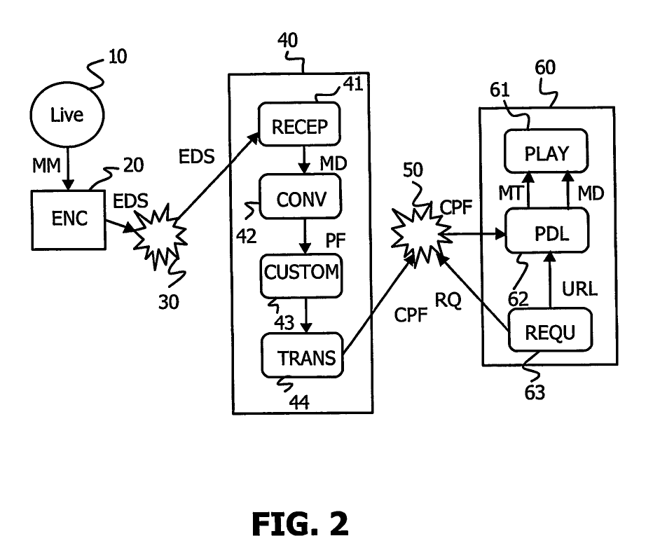

A telecommunication system according to the invention is depicted in FIG. 2. Such a telecommunication system comprises an encoder 20, a first network connection 30 between the encoder 20 and a server 40 and a second network connection 50 between said server and a client device 60. Said encoder encodes multimedia content 10 coming from a content provider in an encoded data stream EDS.

Said encoded data stream may comprise any number of media tracks like a video track, an audio track and possibly a text track or a picture track. It is transmitted in real time via said first network connection 30. In a preferred embodiment of the invention, the RTP (Real Time Protocol) protocol is used as it is often the case for streaming applications, but this is not restrictive. The transport layer of the MPEG-2 standard, called MPEG-2 TS could have been used as well. Said encoded data stream EDS is therefore encapsulated into RTP packets. A RTP packet comprises some encoded data, also called media data, and metadata, which are control data for describing said media data.

It should be noted that the multimedia content MM may be either live content or, in a more general way, any recorded multimedia program, but that said multimedia content is broadcast and not made available on a “video on demand” server. Said first network connection is therefore a multicast broadcasting session, which is “heard” by a number of clients and among them the server 40.

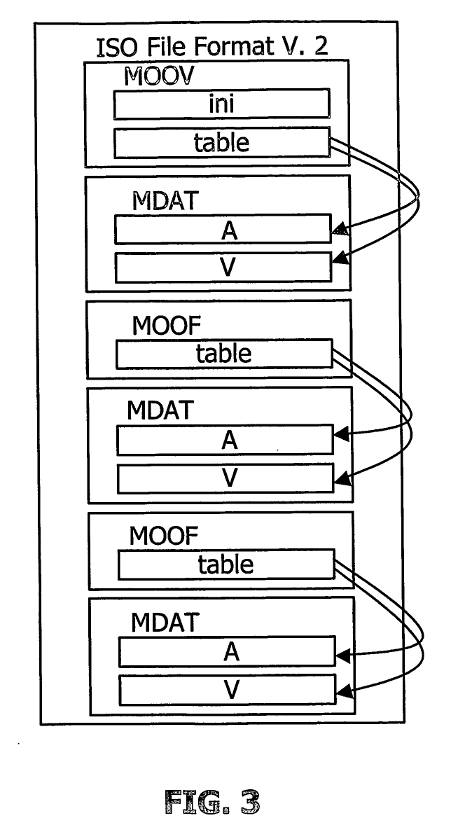

Said stream of RTP packets is received by the reception means 41 of the server 40 and converted into a progressive file PF by stream-to-file converting means 42. Said progressive file PF has a file format comprising interleaved media data and metadata. In a preferred embodiment of the invention, said progressive file is conformant to the ISO File Format version 2. It should be noted that, to be conformant to the ISO File Format version 2, a file only needs to contain both meta and media data, the syntax of data being defined by the standard but not their organization. Referring to FIG. 3, the live file according to the invention is divided into concatenated data boxes, a data box comprising either meta or media data. The ISO file format version 2 defines three types of data boxes:
“MDAT” data boxes, which contain interleaved data chunks of media data like audio A, video V or text T sources. Said data chunks do not have any structure or markers, one “MOOV” and a number of “MOOF” data boxes, which contain metadata for describing and accessing said media data. Said ISO file format starts with a single “MOOV” data box. It is followed by an alternation of “MDAT” and “MOOF” boxes.
Said “MOOV” data box comprises initialization media data like, for instance, elements of a decoder configuration and some index tables for accessing the media data stored in the first MDAT. A “MOOF” data box comprises an index table to access the media data stored in a typically subsequent MDAT.

It should be noted that another file format could be used, like for instance MJPEG or a proprietary file like Apple's .moov file format. An advantage of the ISO file format version 2 is that it is compatible with a number of standards for encoding multimedia data like MPEG-4 for the video track and AMR for the audio track, which means that a file using said format can be played by a decoder compliant with said standards. This is neither the case with a MJPEG file, which needs a MJPEG decoder, nor with a .moov file which is especially designed for an Apple QuickTime player.

The stream-to-file converting means 42 are in charge of filling in the live file structure with the meta and media data contained in the received RTP packets.

It will hereinafter be assumed that the encoded data-stream is an MPEG-4 encoded data stream. This is not restrictive, as already mentioned above, any other format compatible with the ISO file format version 2 could have been used.

Said MPEG-4 encoded data stream is divided into access units. An access unit is a data set, which can be accessed directly. An RTP packet comprises one or several access units coming from the MPEG-4 encoded data stream and some metadata about said access units, said metadata forming a RTP header. In particular, said RTP header comprises an access unit time stamp, indicating at what time said access units have to be decoded.

The stream-to-file converting means 42 mainly consist in creating a progressive file PF using the ISO file format version 2, by:
copying the access units associated with a time stamp into one or several MDAT boxes, each MDAT box having an index,
building the MOOV and MOOF tables of index by associating said time stamp to said MDAT box indexes,
extracting the metadata specifying the decoder configuration from an SDP (Session Description Protocol, a protocol dedicated to the initialization of multimedia sessions) file, said file being usually sent in parallel with the RTP stream to the server, and copy them into the MOOV table of the progressive file.

The obtained progressive file is adapted to progressive download, because it is made of independent data fragments, a data fragment comprising a MOOF data box and a MDAT data box, which can be decoded independently from any other data except the MOOV data box. As a consequence, decoding can start as soon as the MOOV data box has been received by the client, which corresponds to a very short delay.

Said server 40 further comprises transmission means 44 for transmitting said client progressive file to the client device 60. The client device 60, for instance, comprises a web browser for browsing a web page, where the client progressive file CPF is, for instance, made available as a downloadable file. Said client progressive file CPF is transmitted to the client device 60 in response to a client request RQ via a second network connection 50. In the preferred embodiment of the invention, said second network connection 50 uses the HTTP (Hyper Text Transport Protocol) protocol. Said protocol, which is the basis of the World Wide Web, is responsible for transporting HTML documents and manages the traffic on the Internet. However, this is not restrictive, the FTP (File Transport Protocol) could also be used.

Said progressive file is given a basic URL address, for instance http://server:port/american/live/madonna.mpg4. The transmission means 44 comprise redirection sub-means. Said redirection sub-means consist in creating a redirection file, for containing the basic URL address. Said redirection file is given a redirection URL address, for instance http://server:port/redirection/madonna.m4r, which is pointed by a hypertext link, for instance, on a web page. A click on said redirection URL address causes the web browser of the client device 60 to download the redirection file. Once downloaded, the redirection file is read by the web browser. Said web browser is able to identify a MPEG-4 file in the basic URL address and to directly invoke a player 61, which is qualified for handling such a file format. Then, the player reads the URL address contained in the redirection file and directly asks some download means 62 to carry on the download. Said download means 62 are intended to give the player the appearance that the whole file has already been downloaded, whereas only a part of said file is really available, in order to make the player immediately open the progressive file. Once opened, the part of the progressive file already available can be read by virtue of the structure of the ISO file format version 2.

An advantage of the redirection means and the download means 62 according to the invention is to make the progressive download possible. Without any redirection the progressive file PF would have been completely downloaded by the web browser before being transmitted to the player. Without the download means 62, the player would have waited until the end of the download before opening the progressive file PF.

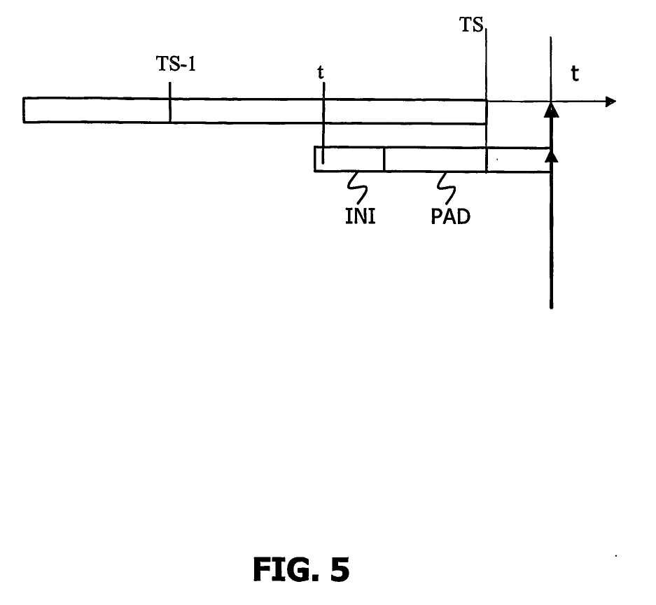

Said server 40 finally comprises customizing means 43 for customizing said progressive file PF into a client progressive file CPF adapted to a client request. A possible structure of said client progressive file is shown in FIG. 5 and will be described below.

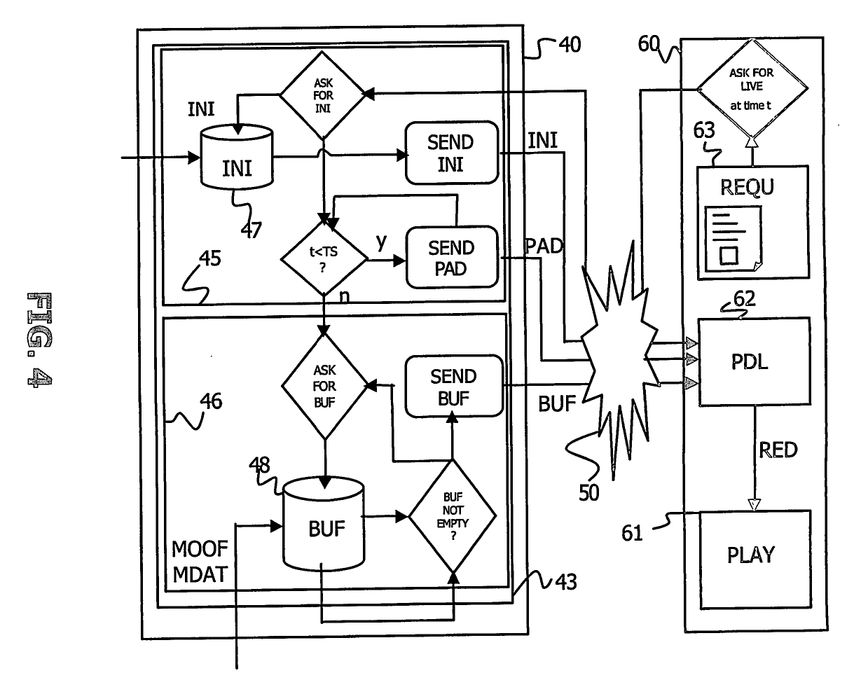

It is assumed that multimedia content has been received as an RTP stream by the server 40 since time to and that said RTP stream is available as a hypertext link towards a progressive file PF on a web page at the server side. A number of clients may be playing said multimedia content simultaneously. Referring to FIG. 4, it is also assumed that a new client, which is browsing the web page of said server, asks for progressively downloading said progressive file PF at time t. An objective of said customizing means 43 is to make said new client catch up the multimedia content as quickly as possible. To this end, said customizing means 43 comprise primer sub-means 45 for providing initialization metadata to said client at time t. Said initialization metadata mainly comprise the decoder configuration, but more generally all the data needed by the client to start receiving the real time encoded data.

An important point is that said encoded data can only be accessed at predetermined time stamps. Said time stamps are related to the above-mentioned access units. An access unit therefore comprises a time stamp indicating at what time the media data it contains are to be played. Some access units are random access points, i. e. they can be accessed directly. Within a video track, for instance, random access points correspond to “intra” images, i. e. to images, which are encoded independently of previous images and can therefore be decoded independently.

The server comprises a buffer BUF for temporarily storing the part of the progressive file corresponding to the last received RTP packets. Said buffer is able to store a fragment of said progressive file, which can be decoded independently of RTP packets not yet received. Such a fragment therefore comprises a MOOF box and a MDAT box. Said MDAT box comprises a number of access units from the different tracks of the encoded data, for instance, from the audio and the video track. Said MOOF box includes an index table for accessing the encoded data contained in said MDAT box. Said fragment therefore comprises more than one access unit time stamps. “Accessible time stamp” TS will hereinafter be called the first access unit time stamp of the MDAT box.

Once said buffer is full, its content is sent as a burst of data to all the connected clients at the same time and the buffer stores a new progressive file fragment

Said buffer is able to store a few seconds of encoded data. This implies that a client will receive the live multimedia content with a delay of a few seconds. On the one hand, this delay should not be too high, especially for a live event like a football match, but on the other hand, the smaller the buffer, the higher the data overhead. As a matter of fact, reorganizing the data into MOOF and MDAT is not costless and a reasonable box size has to be used in order not to affect the compression ratio.

Said primer sub-means 45 are therefore able to:
answer to the client request by sending the decoder configuration INI to the client as the part of the MOOV box of the progressive file corresponding to the initial SDP file,
look for the next accessible time stamp TS occurring after time t. If time t is shorter than the next time stamp TS, then the data contained within said progressive file are not accessible before next time stamp TS. In between, said primer sub-means 45 are able to transmit to said new client additional padding data PAD, which are intended to make the client wait until time stamp TS. These padding data PAD may simply provide a black screen or a logo or even some commercials.

It appears that said progressive file PF is in fact a virtual file, because it may never exist as a whole at the server side. Only a fragment of said live file is available at time t in the buffer BUF.

Said customizing means 43 further comprise starting sub-means 46. Said starting sub-means 45 aim at initiating the transmission of the content of said buffer BUF to the new client, up from said time stamp TS. Said starting sub-means 46 consist, for instance, in adding the address of said client to the list of already registered clients. FIG. 4 shows the data received by a new client from the server from time t. Up from said time stamp TS, said new client exactly receives the same data as the other clients.

This is an additional important advantage of this invention namely, that each client is sent the same data at the same time because it allows superior server performances with minimal hardware resources. Indeed, in classical Video on Demand, the server performances decrease with the number of concurrent different streams the server has to process. For example, a server that can serve 1000 concurrent different streams may be able to serve 2000 or more similar streams depending on the server dynamic memory size, that is on the availability of the data in the dynamic memory instead of the hard disk, the difference in access speed between these storage media being very large. Specifically in the present case, the video server performance is optimal because the maximum memory size required to serve all clients simultaneously is the aforementioned buffer size, which is largely smaller than the typical server dynamic memory.

The decoder configuration INI, the padding data PAD and the media data up from time stamp TS form a customized version of the progressive file PF, that is, a client progressive file CPF specially adapted to the requesting client. Said client progressive file CPF is also a virtual file.

Unlike the first network connection 30, the second network connection 50 is a point to point connection between the server 40 and a client device 60, wherein said server and said client device are both aware of each other. As shown in FIG. 4, the client device 60 comprises requesting means 63 for requesting the progressive file PF available on the server 40, download means 62 for downloading the client progressive file CPF supplied by said customizing means 43 via a second network connection 50 and a player 61 for playing received encoded data RED contained in said client progressive file in real time.

It is to be noted that a classical player is only able to open a local file and cannot download a remote file, i. e. a file located in a remote server. The download means 62, which are known to those skilled in the art, enable the player 61 to handle the received encoded data contained within said progressive file as if they were stored in a local file. Said download means are able to order the download of said progressive file, for instance, by using the HTTP command GET in place of the web browsing means 63. As soon as encoded data from said progressive file are received, the player 61 is able to recognize the ISO file format version 2 and to start decoding said received encoded data RED before the end of the download. Decoded multimedia content DMC is output and displayed.

Said received encoded data RED form a received client progressive file, which may be stored and re-played. It should be noted that the server could be designed to limit the number of authorized copies to the client. Such a limitation could be set up, for instance, by using a DRM (Data Resource Management) technique like the Open Mobile Alliance (OMA) download version 1.

It should be noted that the complete file size may exceed the storage size on the client, in which case progressive download offers the additional advantage that the data corresponding to the beginning of the file can be erased as playback progresses, giving room for more recent data; in this way, effectively endless programs can be made available.

Another advantage of the client device according to the invention is to have no particular specificity, except the ability to achieve progressive download, which is known of those skilled in the art and is becoming widespread. This means that the invention will work with any client comprising a player capable of handling the ISO file format version 2 and download means.

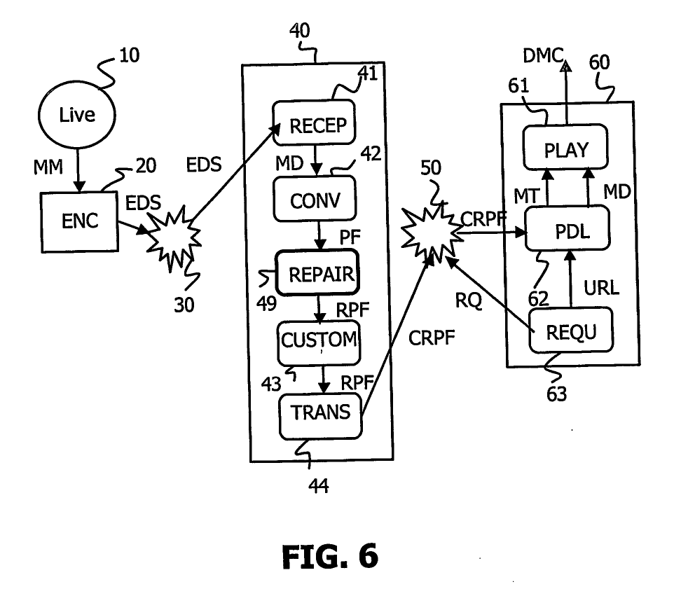

In another embodiment of the invention, said download server 40 further comprises repairing means 49 for completing holes in the progressive file PF, as shown in FIG. 6. Said holes may be caused by a possible loss of data in the real time data stream by the first network connection 30. For instance, if the RTP protocol is used, some RTP packets may be simply lost during transmission or identified as erroneous by the RTP protocol at the server side. In the second case, they may be rejected, because in a real time transmission, there may be no time to ask for packet retransmission. Loss or rejection of RTP packets by the server 40 are both responsible for “holes” in the progressive file created by the converting means 42. Said holes should not cause the player to crash at the client side, because a compliant decoder is expected to be able to cope with missing data in a stream of encoded data by detecting, for instance, that an access unit time stamp is missing. However, said hole will induce a quality drop in the displayed decoded multimedia content.

An advantage of the system according to the invention, which is able to intercept the encoded data during their transmission from the encoder 20 to the client 60, is to benefit from this interception to repair the encoded data on the fly. To this end, the repairing means 48 are able to complete said holes by extrapolating neighbouring data using error resilience techniques. Said error resilience techniques, which are known to those skilled in the art, may handle either compressed or decompressed data. A repaired progressive file RPF is output and a client repaired progressive file CRPF is sent to the client 60.

An additional advantageous set of processing may be performed during the data interception by the server 40. It may consist in customizing the media data contained in said progressive file (PF) as a function of profile data assigned to the client device 60, for instance, by replacing one audio track by another audio track typically for tracks featuring different languages. Indeed it is expected that very wide-scale (i.e. country-wide or even world-wide) programs would be distributed using a number of servers, each server being specific for a given country or region or town or area, in which case the replacement of some sequences by others may be of interest to the user or of economical value for the service provider, for example replacement of advertisements typically by advertisements more targeted to the audience of a given server. Also, instead of having a different processing as described above on a per-server basis, the same server could also perform a specific processing based on other criteria such as user preferences or user profile. Examples of such processing types include language selection and advertisement targeting.

The drawings and their description hereinbefore illustrate rather than limit the invention. It will be evident that there are numerous alternatives, which fall within the scope of the appended claims. In this respect, the following closing remarks are made: there are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions, nor does it exclude that a single function is carried out by an assembly of items of hardware or software, or both. For instance, unlike described in FIGS. 2, 4 and 6, the player 61 could as well be a remote device, independent of the client device 60. Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. A telecommunication system for broadcasting multimedia content (MM) comprising:
an encoder (20) for encoding said multimedia content (M in an encoded data stream (EDS) comprising media data (MD),
a server (40),
a client device (60),
a first network connection (30) for transmitting said encoded data stream (EDS) to said server (40),
said server (40) comprising:
reception means (41) for receiving said encoded data stream (EDS),
stream-to-file converting means (42) for generating metadata (MT) from the media data (MD) contained in the received encoded data stream and for creating a progressive file (PF), in which said media data and said metadata are interleaved,
customizing means (43) for customizing said progressive file (PF) into a client progressive file (CPF) adapted to a client request (RQ), using said metadata (MT),
transmission means (44) for transmitting said client progressive file (CPF) to said client device (60) via a second network connection (50),
said client device (60) comprising:
requesting means for requesting said progressive file (PF) to said server (40),
download means (62) for downloading said client progressive file (CPF) via said second network connection (50) and for providing a player (61) with said received media data (MD) before the end of the download, using said metadata (MT).

2. A system as claimed in claim 1, wherein said progressive file (PF) has the ISO file format version 2.

3. A system as claimed in claim 1, wherein said first network connection (30) uses the Real Time Protocol (RTP).

4. A system as claimed in claim 1, wherein said second network connection (50) uses the Hyper Text Transport Protocol (HTTP).

5. A server (40) for receiving broadcasted multimedia content as an encoded data stream (EDS), comprising media data (NM) and for transmitting said media data (MD) to a client device (60), said server (40) comprising:
reception means (41) for receiving said encoded data stream (EDS),
stream-to-file converting means (42) for generating metadata (MT) from the media data (MD) contained in the received encoded data stream and for creating a progressive file (PF), in which said media data (MD) and said metadata (MT) are interleaved,
customizing means (43) for customizing said progressive file (PF) into a client progressive file (CPF) adapted to a client request EQ), using said metadata (MTs),
transmitting means (44) for transmitting said client progressive file (CPF) to said client device (60).

6. A server (40) as claimed in claim 5, wherein said progressive file (PF) comprises time stamps for accessing said media data (MD) and, for a client request (RQ) at time t, said customizing means (43) comprise:
primer sub-means (44) for providing initialization metadata to said client device (60) at time t,
starting sub-means (45) for starting the download of said progressive file (PF) at a time stamp (TS) greater than said time t.

7. A server as claimed in claim 5, comprising repairing means (48) for repairing holes in said progressive file (PF), said holes being caused by a loss of data in the received encoded data stream.

8. A client device (60) for requesting broadcast multimedia content (N) from a server (40) as a progressive file CPF), said progressive file comprising interleaved media data (MD) and metadata (MT), said client device (60) comprising:
requesting means (63) for requesting said progressive file (PF) to said server (40),
download means (62) for downloading said progressive file (PF) via a second network connection (50) and for providing a player (61) with said media data (MD) before the end of the download, using said metadata (MT).

9. A method of broadcasting multimedia content, comprising the steps of:
encoding said multimedia content in an encoded data stream (EDS), comprising media data (MD),
transmitting said encoded data stream (EDS) to a server (40),
generating metadata (MT) from said media data (MD) and creating a progressive file (PF), comprising interleaved meta and media data,
customizing said progressive file into a client progressive file (CPF) adapted to a client request (RQ),
transmitting said client progressive file (CPF) to a client device (60),
downloading said client progressive file (CPF) and start playing said received multimedia content before the end of the download using said interleaved metadata (MT) and media data (MD).

10. A method as claimed in claim 9, comprising a step of customizing the media data (MD) contained in said progressive file (PF) as a function of profile data assigned to the client device (60).

11. A computer program comprising a set of instructions which, when loaded into a processor or a computer, causes the processor or the computer to carry out the method as claimed in claim 9.

12. A signal carrying a program as claimed in claim 11.
